(19) United States
(12) Patent Application Publication
(10) Pub. No.: US 2007/0132889 A1
(43) Pub. Date: Jun. 14, 2007

(54) INTEGRATED DIGITAL TELEVISION TUNER

(75) Inventor: JIANPING PAN, SAN DIEGO, CA (US)

Correspondence Address: JIANPING PAN, 12925 CAMINITO BESO, SAN DIEGO, CA, 92130, US

(73) Assignee: JIANPING PAN, SAN DIEGO, CA (US)

(21) Appl. No.: 11/563,124

(22) Filed: Nov. 24, 2006

Related U.S. Application Data
(60) Provisional application No. 60/597,362, filed on Nov. 28, 2005.

(51) Int. Cl. H04N 5/455

(52) U.S. Cl. 348/726

(57) ABSTRACT

A highly integrated terrestrial and cable tuner for receiving digital television signals is disclosed. It achieves high performances in sensitivity, image rejection, dynamic range, channel selectivity and power consumption. The tuner first converts an RF input signal into a high-frequency first intermediate frequency (IF) using a single quadrature image rejection converter. Consequently, it significantly relaxes RF filter design. A second converter downconverts the first IF signal into either a baseband signal or a low-IF signal. The tuner can interface with a demodulator having the baseband and/or low-IF input interface. The tuner is integrated by using standard processes, with minimal off-chip components excluding SAW and LC filters. Small tuner modules cost less than discrete (can) tuners. They can be used in digital TV sets and portable/handheld TV devices.

### CROSS-REFERENCE TO RELATED APPLICATIONS

This application claims the benefit of U.S. Provisional Patent Application No. 60/597362 filed Nov. 28, 2005; the contents of which are hereby incorporated by reference.

### FIELD OF THE INVENTION

This invention relates to highly integrated receivers and more particularly to highly integrated tuners used in both terrestrial and cable systems for receiving television signals and cable modem signals.

### BACKGROUND OF THE INVENTION

The present invention relates to highly integrated tuners. Such tuners can be applied for receiving any type of television (TV) signal having analog or digital formats from a terrestrial aerial or cable distribution network. Such tuners can be used as RF receivers for cable modems.

The frequency band where terrestrial TV channels are typically allocated is, approximately, in range of 50 MHz to 870 MHz. Channel bandwidths of 6 MHz and 8 MHz are adopted in many regions around the world. Standards of NTSC, PAL, and SECAM are most popular among the analog standards used for transmission of color TV signals. A digital terrestrial TV uses the spectrum in the same frequency band and shares the channels with the analog TV. The modulation methods used in the digital terrestrial TV are defined in the digital TV standards. For example, Vestigial Side Band modulation (VSB) is used in the USA, and Coded Orthogonal Frequency Division Multiplexing (COFDM) modulation is used in Europe.

The cable TV (CATV) network, the TV broadcasting over cable distribution network, uses a regular band which is basically similar to the signal band of the terrestrial TV, although the low-edge of the band can be different in different ranges around the world, for example, in North America and in Europe. The analog cable TV uses the same modulation formats and channel spacing as the analog terrestrial TV. The digital cable TV shares the channels with the analog cable TV and mostly uses Quadrature Amplitude Modulation. The cable modem system is defined to utilize some of the channels in the regular TV signal band for downstream transmission and use the spectrum in a lower frequency band for upstream transmission. The frequency band is recently extended to 1 GHz as an optional extended band of the cable distribution network.

The function of a tuner, as a RF receiver, is to amplify a radio frequency (RF) signal from an antenna or a cable connector and convert the RF signal into a final intermediate frequency (IF) signal. One issue in the tuner design is that the ratio between the overall bandwidth of the signal band of 50 to 870 MHz and the center frequency is very high. The special tuner architectures are required to cope with this issue in the integrated tuner design.

One of the integrated tuners presently in use is a dual-conversion tuner, which has a first-stage upconverter and a second-stage downconverter. The dual-conversion tuner first upconverts the input RF signal of a selected channel to a first IF using a real-signal upconverter without image rejection capability and then downconverts the first IF signal to an output IF. The first IF center frequency is defined to be higher than the signal band and usually in the range of 1.0 to 1.3 GHz. The final IF frequency is often defined as 44 MHz for NTSC and 36 MHz for PAL, respectively (or, often as 43.75 MHz for NTSC and 36.125 MHz for PAL, respectively). The high frequency of the first IF increases significantly the image offset from the desired signal in the RF stage. The first-stage upconversion results in a relaxed design of the RF image rejection filter. However, it creates a difficult task for a filter in the first IF stage to reject the image in the second-stage downconversion. In the first IF stage, the image offset from the desired signal is twice the final IF frequency, equal to 2×44=88 MHz in the case of NTSC or 2×36=72 MHz in the case of PAL. The resulting ratio between the center frequency of the first IF (1 GHz to 1.3 GHz) and the image offset is significantly high. For a typical image rejection of 50 to 60 dB, this requires a high-Q bandpass filter design, and it is extremely difficult, if not impossible, to integrate this high-Q bandpass filter of an adequate dynamic range, even by using a high performance process, for example, of Silicon Germanium BiCMOS. Consequently as one of the disadvantages in this dual-conversion tuner, an external surface acoustic wave (SAW) filter is needed to provide this image rejection in the first IF stage, and some other discrete components may also be needed for the circuit matching and overall filter frequency response. The use of the external SAW filter at the high frequency first IF may degrade performance of dynamic ranges of the circuit blocks both in the RF stage and in the first IF stage.

The second type of integrated tuners is a single-conversion tuner, and it has some applications in cable systems. Although the single-conversion has been long used in building the discrete tuners, it is presently employed in product designs of the integrated tuners. In this single-conversion integrated tuner, image rejection is achieved by a RF polyphase filter and a double quadrature downconverter in conjunction with an IF polyphase filter. By using a lower final IF in the range of 4 to 5 MHz for cable modem applications rather than the common-used IF of 44 or 36 MHz, a better matching performance is obtained in the double quadrature downconverter and IF polyphase filter. However, essentially limited by the architecture, this single-conversion tuner tends to deliver a moderate image rejection performance of about 50 dB. While this image rejection performance may be acceptable in cable TV or cable modem applications, it is evidently too low in terrestrial TV applications where much stronger interference signals exist in and above the TV signal band. Note that the image rejection performance may be degraded if this single-conversion architecture is employed in a tuner having the common-used IF of 44 or 36 MHz. This is because that the circuit quadrature mismatch will typically increase when a high operating frequency is used, resulting in a degradation in image rejection performance. Besides, the stringent image rejection requirement of the RF filter in this single-conversion architecture results in a decreased dynamic range in the RF stage in dealing with varieties of large interference signals.

Accordingly, it is the objective of this invention to provide a highly integrated tuner which only has a minimum number of insensitive discrete components but does not require any external filters, thereby minimizing the size of an application circuit board and thus providing much lower product cost than those of discrete TV tuners presently in use.

It is another objective of the present invention to provide a highly integrated tuner which can be used in both terrestrial and cable systems for receiving TV signals and data signals.

It is yet another objective of the present invention to provide a highly integrated tuner which achieves high performance of image rejection, dynamic range and channel selectivity and has low power consumption.

### SUMMARY OF THE INVENTION

A dual-conversion tuner architecture of first-stage high-frequency IF conversion and second-stage zero-IF downconversion is first disclosed by this invention. The first-stage single quadrature conversion relaxes the design of an RF image rejection filter. The second-stage zero-IF downconversion relaxes the design of a first-IF bandpass filter, and it provides a baseband output to interface with a demodulator with a baseband input.

A dual-conversion tuner architecture of first-stage high-frequency IF conversion and second-stage low-IF downconversion is then disclosed by this invention. The first-stage single quadrature conversion relaxes the design of an RF image rejection filter. The second-stage low-IF image rejection downconversion makes it possible for a simple first-IF bandpass filter only to reject high-order images, and it provides a low-IF output to interface with a demodulator with a low-IF input.

### BRIEF DESCRIPTION OF THE DRAWINGS

This present invention will be better understood from the following detailed description. Such description makes reference to the accompanying drawings, in which:

FIG. 1 is a block diagram of a preferred embodiment of an integrated tuner of dual-conversion architecture of the present invention, where the second conversion is a zero-IF downconversion;

FIG. 2A is a type-I single quadrature converter having a real signal input, a quadrature LO input and a quadrature output, FIG. 2B is a type-II single quadrature converter having a quadrature signal input, a real LO input and a quadrature output, and FIG. 2C is a double quadrature converter having a quadrature signal input, a quadrature LO input and a quadrature output;

FIGS. 3A-3E illustrate the operational principle of a type-I single quadrature converter, and FIGS. 3F-3H illustrate the operational principle of a basic, real converter;

FIG. 4 is a schematic diagram of a passive mixer;

FIG. 5A is a simplified schematic diagram of an active CMOS switching mixer, and FIG. 5B is a simplified schematic diagram of an active combined CMOS/bipolar switching mixer;

FIG. 6A is a schematic diagram of a polyphase filter having quadrature differential inputs and outputs, FIG. 6B is a schematic diagram of a polyphase filter having single differential inputs and quadrature differential outputs, and FIG. 6C is a schematic diagram of a polyphase filter having quadrature differential inputs and single differential outputs;

FIG. 7 is a block diagram of a quadrature LO signal generator comprising a frequency synthesizer and a quadrature signal generator;

FIG. 8 is a block diagram of a Sigma-Delta fractional-N frequency synthesizer for generating LO (or reference) signals;

FIG. 9 is a block diagram of another preferred embodiment of an integrated tuner of dual-conversion architecture of the present invention, where the second conversion is a zero-IF downconversion;

FIG. 10 is a block diagram of another preferred embodiment of an integrated tuner of dual-conversion architecture of the present invention, where the second conversion is a zero-IF downconversion;

FIG. 11 is a block diagram of a preferred embodiment of an integrated tuner of dual-conversion architecture of the present invention, where the second conversion is a low-IF downconversion;

FIG. 12 is a semi-schematic diagram of a stage of a multi-stage operational amplifier based complex bandpass filter;

FIG. 13 is a block diagram of another preferred embodiment of an integrated tuner of dual-conversion architecture of the present invention, where the second conversion is a low-IF downconversion; and

FIG. 14 is a block diagram of another preferred embodiment of an integrated tuner of dual-conversion architecture of the present invention, where the second conversion is a low-IF downconversion.

### DETAILED DESCRIPTION OF THE INVENTION

This invention is to provide a highly integrated silicon tuner which is implemented on a single integrated circuit. However, uses of some external components in the integrated tuner or on the module of it are obviously allowable and may result in an equivalent and slightly better circuit performance. The differential circuit design is used in this invention in all the circuits wherever it is suitable to reject the common-mode sources and even-order nonlinear distortions, and therefore, all issues related to even-order nonlinear distortions and even-number harmonics should be addressed mainly by careful differential circuit designs and proper layout techniques.

The following definitions and representations are used in this context which also covers the section of claims. A quadrature signal represents a complex signal which has an in-phase component and a quadrature component. In a quadrature-signal processing circuit block, I represents an in-phase component or path and Q a quadrature component or path. A total I/Q mismatch is conveniently defined to represent an equivalent total of I/Q amplitude mismatch and phase error. The total I/Q mismatch satisfies the relationship of A=20 log₁₀(B), where B in percentage is the total I/Q mismatch, and A in decibel (dB) is a frequency-crosstalk of a mirror signal to a desired signal. A frequency band represents a frequency range where a radio frequency (RF) signal being received is located. The regular frequency bands in terrestrial TV systems and cable networks are approximately from 50 to 880 Mega-Hertz (MHz). An extended frequency band in cable networks is approximately from 40 MHz to 1 Giga-Hertz (GHz). A channel spacing (a distance between two adjacent channels) in the frequency band is typically 6, 7 or 8 MHz but may be smaller, like for a radio broadcast signal of audio. A local oscillator (LO) signal and a reference signal are equivalent, a reference (or LO) signal represents a reference (or LO) signal of square-wave form, and a frequency of a reference (or LO) signal represents a fundamental frequency of the reference (or LO) signal of square-wave form. A mixer represents a subtractive switching mixer using a square-wave reference (or LO) signal. A converter represents a frequency converter based on subtractive switching mixers and using a real or quadrature reference (or LO) signal, of square-wave form. Three types of conventional quadrature converters in the art will be used later, that is, a double quadrature converter having a quadrature signal input, a quadrature reference input and a quadrature output, a type-I single quadrature converter having a real signal input, a quadrature reference input and a quadrature output, and a type-II single quadrature converter having a quadrature signal input, a real reference input and a quadrature output. A quadrature converter is often conveniently used to represent one of these three quadrature converters. The frequency or the center frequency of an intermediate frequency (IF) signal represents the center frequency of a desired signal in the IF signal.

In a conventional downconverter in the art, switching mixers which use square-wave reference signals are typically used for achieving large-signal linearity. As a sequence, the downconverter, having a square-wave reference signal, not only converts a desired signal in an RF signal to an IF, but also mixes some other unwanted signals in the RF signal with harmonics of the reference signal into a narrow range at a center frequency of the IF signal, being superimposed on the desired signal in the IF signal. Because these high-order mixing products have the same effect as an image on the desired signal in the IF signal, the unwanted signals in the RF signal corresponding to these high-order mixing products are hereby termed as high-order images. Note that a high-order hereby means an odd- or even-number order higher than the first-order. For example, the third- and fifth-order images being mixed respectively with the third and fifth harmonics of a reference signal are converted to the IF signals. Accordingly an ordinarily-defined image is hereby called as a (first-order) image, a first-order image or simply an image. Note that as said, the issues related to even-number harmonics of reference signals, that is, even-number high-order images should be addressed mainly by careful differential circuit designs and proper layout techniques. In the following for convenience, a target overall image rejection of 80 dB will be often used, as a design example.

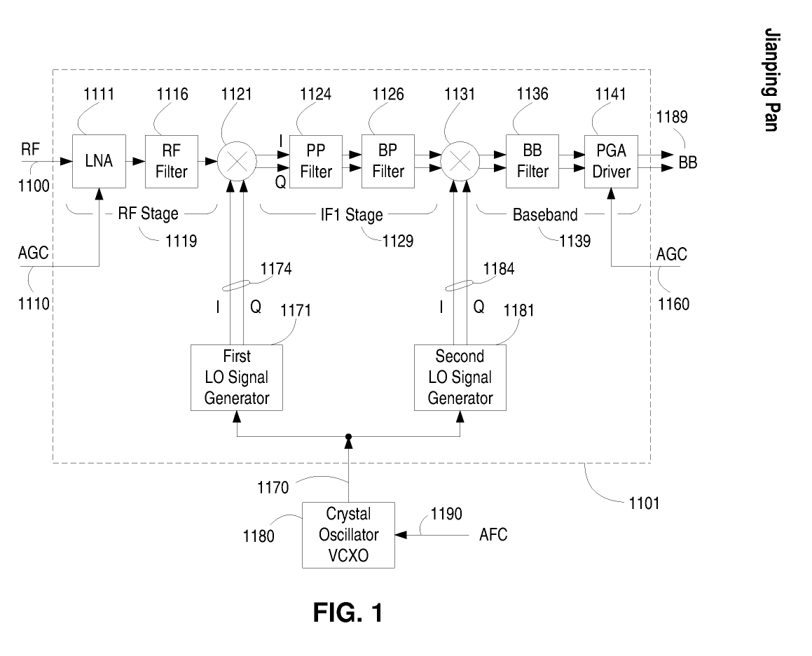

FIG. 1 is a block diagram of a preferred embodiment of an integrated tuner of dual-conversion architecture 1101 in accordance with the present invention. A Low Noise Amplifier (LNA) 1111 first amplifies an RF signal 1100 from a terrestrial aerial or cable distribution network so that the subsequent noisy circuit blocks do not provide significant contributions to the system noise figure (NF) of the RF receiver. The gain of LNA 1111 is controlled by an external automatic gain control (AGC) signal 1110. An RF image rejection (IR) filter 1116 next rejects the image in a first frequency conversion 1121. First conversion 1121 converts the desired signal of a selected channel in the signal band to a first high-frequency intermediate frequency (IF1). A type-I single quadrature converter is used in this conversion 1121 to provide an image rejection of about 40 dB. The design requirement of RF IR filter 1116 is consequently reduced by about 40 dB. After first conversion 1121, a bandpass filter 1126 in IF1 stage 1129 rejects the high-order images in a next zero-IF downconversion. A polyphase filter 1124 may be utilized for the image rejection purpose. A zero-IF double quadrature downconverter 1131 downconverts the desired signal in IF1 stage 1129 to a baseband 1139. Benefited from zero-IF downconversion 1131, IF1 filter 1126 is now only for the rejection of the high-order images and can be advantageously integrated using a low-Q filter design. A baseband lowpass (LP) filter 1136 provides channel selection and suppresses interference signals according to system specifications of digital TV standards. A programmable gain amplifier (PGA) in a PGA/Driver block 1141 amplifies the desired signal according to an external AGC signal 1160. A driver in PGA/Driver block 1141 provides a low impedance baseband output 1189 to interface with analog-to-digital (A/D) converters of the digital demodulator. Two LO signal generators 1171 and 1181 provide LO (or reference) signals to converters 1121 and 1131. A crystal oscillator 1180 generates a low phase noise reference-source frequency 1170 used by LO signal generators 1171 and 1181. The frequency of crystal oscillator 1180 may be fine-tuned by an external automatic frequency control (AFC) signal 1190. First LO signal generator 1171 provides a tunable-frequency quadrature LO signal 1174 for channel tuning.

Detailed description of operation, design and requirements of the circuit blocks in the integrated tuner of dual-conversion architecture 1101 in FIG. 1 is provided in the following paragraphs. In this context, for the convenience, the four-digit reference numerals with 11 in the left-most two digits identify the circuit blocks in integrated tuner 1101 in FIG. 1.

LNA 1111 should be designed to have a flat frequency response and a consistent input impedance of 75 Ω over the entire signal band and a high spurious-free dynamic range in order to cope with strong interference signals. At the maximum gain, LNA 1111 is expected to have a noise figure on the order of 2 dB and a satisfactory third-order input intercept point (IIP3) according to system specifications. LNA 1111 may be designed as a one- or two-stage differential amplifier and configured to have a single-end input and a differential output. The maximum gain of LNA 1111 can range from 15 to 30 dB. The cable distribution network is in general well regulated so that the signal strength varies in a relatively narrow range of about −15 to +20 dBmV. The signal in the terrestrial TV network can vary in a wider range of approximately −90 to −10 dBm. LNA 1111 normally needs to have at least two gain settings, and these gains can be programmed by external AGC signal 1110. The programmable gain range may be from 10 to 20 dB. AGC signal 1110 is typically generated by a digital demodulator in accordance with the received desired signal strength. For cable application, LNA 1111 may be designed to have an attenuator and a LNA amplifier in series. The attenuator is used to reduce the strength of RF input signal 1100 so that the LNA amplifier can be protected from being over-driven into the nonlinear range. Signal strength detectors (not shown) can be placed in several places in RF stage 1119, for example, at LNA 1111 output and/or RF IR filter 1116 to obtain the detection signals. These signal strength detectors can be utilized to locally control the gain and attenuation in LNA 1111 in case that unexpected strong inference signals occur at RF input 1100. LNA 1111 may interface, at RF input port 1100, with a diplexer or diplex filter (not shown) when the tuner is used in a system with bi-directional transmission of downstream and upstream, for example, a cable modem. LNA 1111 may interface, at RF input port 1100, with a splitter (not shown) which is provided in a system with more than one RF receiver. Note that there may be an external filter at RF input port 1100 for filtering some strong interference signals, especially in terrestrial application.

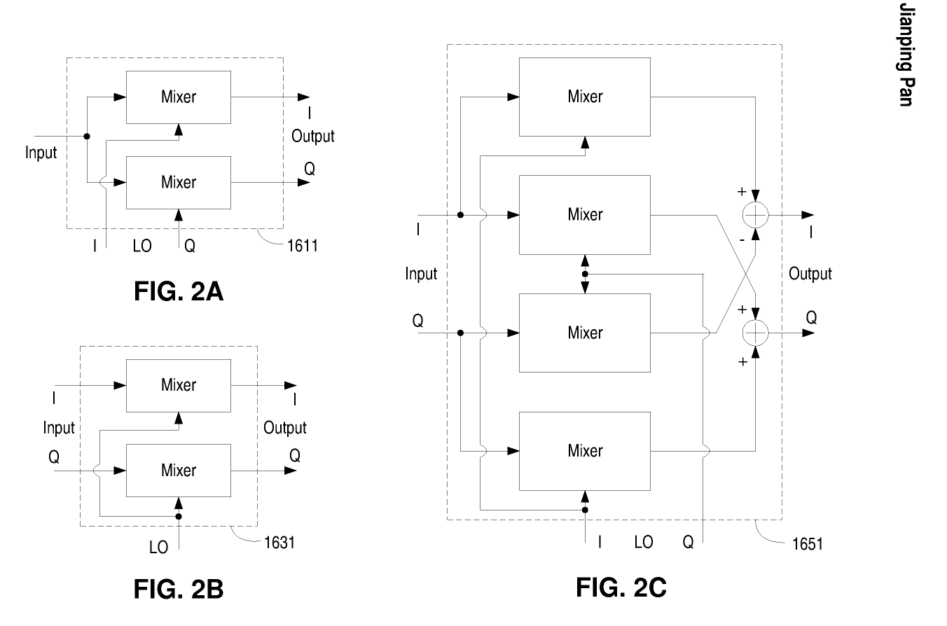

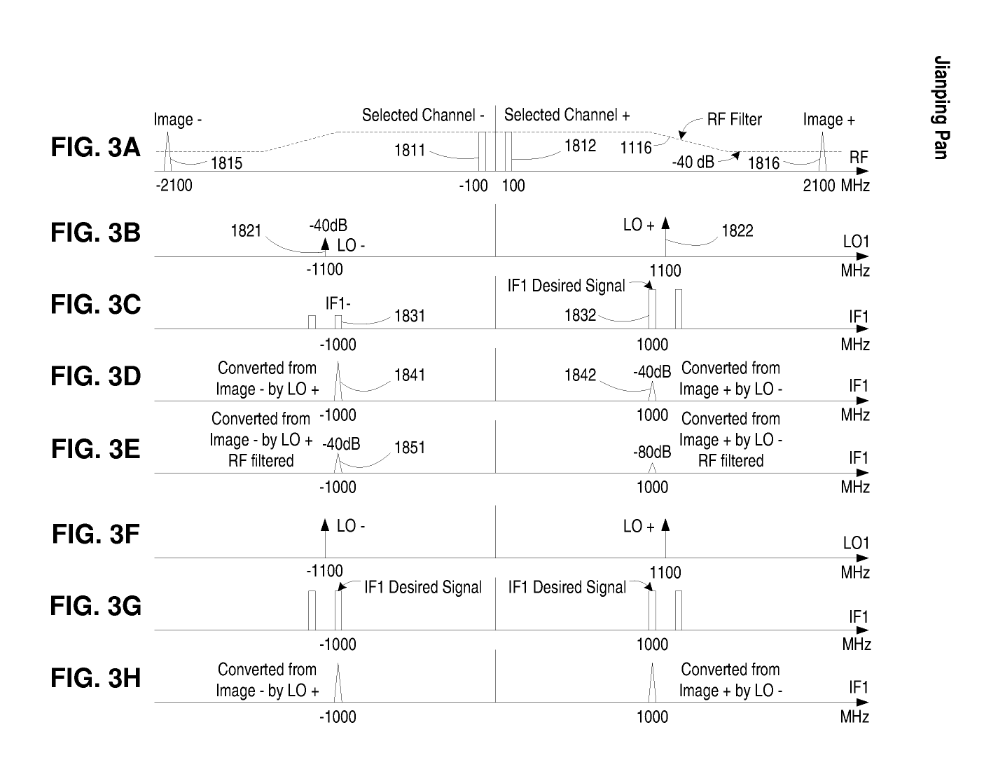

In first conversion 1121, the type-I single quadrature frequency converter is used to relax the design requirement of RF IR filter 1116. FIG. 2A shows an embodiment 1611 of type-I single quadrature converter 1121. FIG. 3 illustrates the operational principle of single quadrature converter 1121, which only shows the signals of interest before and after the conversion. FIG. 3A shows negative and positive sidebands 1811 and 1812 of a selected channel at RF input port 1100 and negative and positive sidebands 1815 and 1816 of an image signal. Quadrature LO signal 1174 is denoted as a complex signal of LO(t)=LOₗ(t)+j LO_{Q}(t):

$$\begin{matrix}{LO}_{I} ( t ) = \frac{4}{π} \{ \begin{matrix}cos ( {ω}_{LO} t ) - \frac{1}{3} cos ( 3 {ω}_{LO} t ) + \frac{1}{5} cos ( 5 {ω}_{LO} t ) - \\ \frac{1}{7} cos ( 7 {ω}_{LO} t ) + \frac{1}{9} cos ( 9 {ω}_{LO} t ) -\end{matrix} … \} & ( 1 ) \\ {LO}_{Q} ( t ) = \frac{4}{π} \{ \begin{matrix}sin ( {ω}_{LO} t ) + \frac{1}{3} sin ( 3 {ω}_{LO} t ) + \frac{1}{5} sin ( 5 {ω}_{LO} t ) + \\ \frac{1}{7} sin ( 7 {ω}_{LO} t ) + \frac{1}{9} sin ( 9 {ω}_{LO} t ) +\end{matrix} … \} & ( 2 ) \\ LO ( t ) = \frac{4}{π} \{ \begin{matrix}ⅇ ( {jω}_{LO} t ) - \frac{1}{3} ⅇ ( - {j3ω}_{LO} t ) + \frac{1}{5} ⅇ ( {j5ω}_{LO} t ) - \\ \frac{1}{7} ⅇ ( - {j7ω}_{LO} t ) + \frac{1}{9} ⅇ ( {j9ω}_{LO} t ) -\end{matrix} … \} & ( 3 )\end{matrix}$$

In this illustration, the wanted fundamental frequency of quadrature LO signal 1174 is at the positive frequency, i.e., f_{LO}=ω_{LO}/(2Π). FIG. 3B shows a quadrature LO signal of a total I/Q mismatch of 1% at negative and positive frequencies 1821 and 1822. Assume that the internal mismatch of the switching mixers inside converter 1121 is negligible. FIG. 3C shows that after the conversion, desired signal sideband 1832 in IF1 stage 1129 is situated at the positive frequencies; the 40 dB suppressed signal 1831 is situated at the negative frequencies as a mirror signal to desired signal sideband 1832. Desired signal sideband 1832 in IF1 stage 1129 is the desired signal in the next zero-IF double quadrature downconversion 1131.

FIG. 3D shows converted image 1841 of no rejection situated at the negative frequencies of IF1 1129, as another mirror signal to desired signal sideband 1832, and converted image 1842 of a 40 dB rejection situated at the positive frequencies. Converted image 1842 co-exists with desired signal 1832 in IF1 stage 1129 at the positive frequencies. Therefore converted image 1842 acts as a co-channel interference signal relative to desired signal 1832 but underwent the 40 dB rejection. In IF1 stage 1129 quadrature signal domain, converted image 1841 at the negative frequencies, as the mirror signal, and desired signal 1832 (at the positive frequencies) are well separated, assuming that there is a good enough I/Q match performance in IF1 stage 1129. As a consequence, this single quadrature converter 1121 provides the capability of image separation (although it does not actually reject converted image 1841 at the negative frequencies). Converted image 1841 can be then rejected using conventional polyphase filter 1124 which is designed to have a notch at converted image 1841. Alternatively, converted image 1841 can be rejected next in a double quadrature image rejection converter. Or converted image 1841 can be jointly rejected by these two circuit blocks.

For comparison, FIGS. 2F, 2G and 2H show a basic frequency converter of single differential input and output. The figures show that the basic converter does not possess the image rejection capability described above.

RF IR filter 1116 in RF stage 1119 is employed to reject the image in first conversion 1121. The image offset from the desired signal in RF stage 1119 is twice the center frequency of IF1 1129. The use of single quadrature converter 1121 significantly reduces the design requirement of RF IR filter 1116. For a target overall image rejection of 80 dB, RF IR filter 1116 is required only to provide an image rejection of about 40 dB, as illustrated in FIG. 3A. FIG. 3E shows converted image 1851 of this amount of rejection. Note that this image rejection requirement of RF IR filter 1116 is only half of that required if using a basic frequency converter.

The first preferred IF1 1129 frequency planning is to define the center frequency of IF1 1129 as 1 GHz or higher for relaxing the design constraint of RF IR filter 1116. The frequency upconversion in first conversion 1121 increases the image frequency offset from the desired signal in RF stage 1119. Furthermore, single quadrature converter 1121 tends to reduce image rejection requirement of RF IR filter 1116, by about 40 dB. Thus for the target overall image rejection of 80 dB, RF IR filter 1116 is required to provide a rejection of about 40 dB at the image of the large frequency offset. The design of RF IR filter 1116 is consequently simple and can use a conventional filter design technique. For example, RF IR filter 1116 can be designed as a cascade of RC lowpass filters. A simple RF IR filter 1116 design is desirable since it tends to deliver a large dynamic range, which is crucial to the circuit performance in RF stage 1119. Practically, in order to have even-distributed image rejection across the entire signal band, a bank of switchable filters is designed for RF IR filter 1116. Each of the filters is dedicated to reject the images corresponding to a subband of the channels and is switched accordingly. In a simplest embodiment, each of the filters may comprise one to three simple RC lowpass/highpass stages. Besides, these RC stages may be partially or fully implemented in LNA 1111 block. For high-frequency subbands, LC bandpass filters can be designed in RF IR filter 1116 bank. RF IR filter 1116 bank is then a combination of RC lowpass/highpass and LC bandpass filters. Auto-tuning may not be needed in these low-Q filters. Additionally, prior-art GmC bandpass and lowpass filters may be considered in RF IR filter 1116 bank for rejecting the images related to the lower-frequency subbands.

The second preferred IF1 1129 frequency planning is to define the center frequency of IF1 1129 as below 1 GHz for better I/Q match performance of zero-IF downconverter 1131. Although lowering the frequency of IF1 1129 can typically improve the I/Q matching in zero-IF downconverter 1131, it causes the image offset from RF desired signal 1100 smaller, increasing the design constraint of RF IR filter 1116. RF IR filter 1116 bank then likely comprise a combination of RC lowpass and highpass, GmC lowpass/bandpass and LC bandpass filters, depending on the IF1 frequency planning. In the GmC filter design, a low Q design is desirable because thermal noise of the filter is substantially proportional to the Q value when using a CMOS design. A BiCMOS or SiGe BiCMOS process can provide the maximum flexibility of implementing RF IR filter 1116 bank. The low-Q GmC filters may incorporate with conventional frequency tuning but may not need Q tuning. The GmC filters work adequately for lower-frequency subbands while the LC filters are suitable for the higher-frequency subbands.

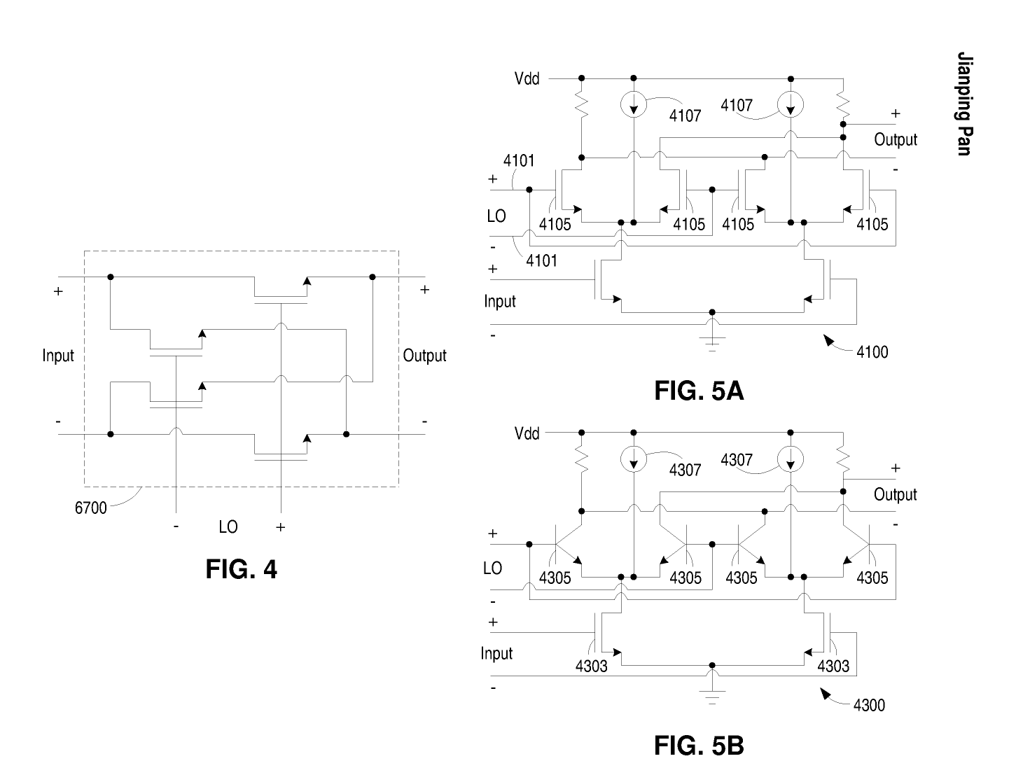

Type-I single quadrature converter 1121 mixes RF signal 1119 with quadrature LO signal 1174 and outputs quadrature IF1 signal 1129. FIG. 2A shows an embodiment 1611 of type-I single quadrature converter 1121. Either active switching mixers or passive CMOS mixers may be used in the single quadrature converter 1121. A passive mixer 6700 shown in FIG. 4 has good linearity, but it has voltage loss of about 4 dB and sometimes needs output buffer amplifiers depending on the input stage of a next circuit block. Also it may have weak reverse isolation. An active switching mixer, as one of mixers 4100 and 4300 shown in FIGS. 5A and 5B, has better reverse isolation and can provide a small conversion gain, but it has poorer linearity.

The desired signal in IF1 stage 1129 next needs to be downconverted. This present dual-conversion tuner 1101 advantageously employs a zero-IF downconversion in stage 1131 to significantly relax the design of IF1 bandpass filter 1126. The zero-IF double quadrature IR downconverter is used in second conversion 1131. Returning to FIGS. 3A, 3C and 3E, RF IR filter 1116 tends to reject the image signal 1851 by about 40 dB. Due to the quadrature signal representation of IF1, the wanted positive sideband of desired signal 1832 and image signals 1851 and 1831 at the negative frequencies are maintained in separation. For the target overall image rejection of 80 dB, first consider a design case which does not has IF polyphase filter 1124. The circuitry in entire IF1 stage 1129 then needs to provide better than 40 dB rejection of the crosstalk of image signals 1851 and 1831 to desired signal 1832. The total circuitry I/Q mismatch of IF1 stage 1129 is then required to be smaller than 1%. Additionally, zero-IF double quadrature IR downconverter 1131 is required to provide image rejection of 40 dB. By using IF polyphase filter 1124 to provide certain amount of rejection of image signals 1851 and 1831, the I/Q matching requirements of the circuitry in entire IF1 stage 1129 and zero-IF double quadrature IR downconverter 1131 can be reduced, sometimes significantly.

Because zero-IF double quadrature IR downconverter 1131 typically comprises switching (or switching-type) mixers, it not only downconverts the desired signal to baseband 1139, but also mixes other interference signals in IF1 stage 1129 with the harmonics of quadrature LO signal 1184. As a consequence, bandpass filter 1126 in IF1 stage 1129 is needed to reject these high-order images in zero-IF double quadrature downconversion 1131, but the design constraint of BP filter 1126 becomes much relaxed. The strongest high-order image is the third-order image. The offset of the third-order image from the desired signal in IF1 stage 1129 is twice the frequency of IF1 1129. Due to the large frequency offsets of the high-order images, a low-Q bandpass filter 1126 can be integrated on-chip to provide a satisfactory rejection of the high-order images. It should be understood that the functionality of this low-Q on-chip bandpass filter 1126 is completely different from that of an external SAW filter in a dual-conversion integrated tuner of the prior art, where the SAW filter of very narrow bandwidth is required at the first IF stage to reject the (first-order) image which has the offset of only 2×44 MHz or 2×36 MHz from the desired signal. In this embodiment, for the target overall image rejection of 80 dB, IF1 bandpass filter 1126 is in general required to reject the third-order image by about 60 dB, because type-I single quadrature converter 1121 and zero-IF downconverter 1131 provide a total attenuation of about 20 dB of this image. When the frequency of IF1 1129 is high, a cascade of two or three LC bandpass filters can be implemented for IF1 filter 1126. A polyphase filter 1124 may be employed in IF1 stage 1129 to relax the design constraint of IF1 filter 1126, which will be described later. Note that in the quadrature signal structure, the conventional implementation of a bandpass filter (a real signal filter, not a complex filter) is to place two identical filters in the both I and Q signal paths.

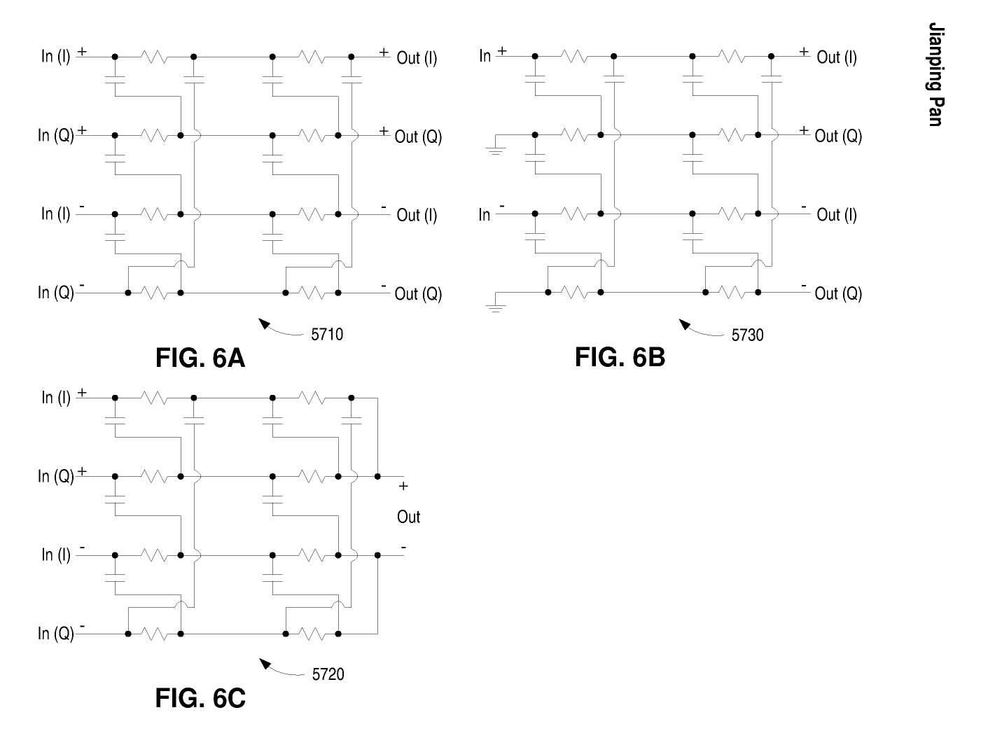

Polyphase filter 1124 in IF1 stage 1129 can be used to provide a notch of 20 to 40 dB at the (first-order) image. This use of polyphase filter 1124 can relax the I/Q matching requirements of the following blocks of IF1 BP filter 1126 and zero-IF downconverter 1131. An embodiment of polyphase filter 1124 is depicted in FIG. 6A as a cascade of two polyphase filters 5710. Polyphase filter 1124 can be arranged to provide enough bandwidth by defining small offsets among the notch frequencies of the filter stages. Locations of polyphase filter 1124 and band pass filter 1126 may be exchanged (not shown). When polyphase filter 1124 is not used, it is just bypassed.

Polyphase filter 1124 can also be used to relax the design constraint of IF1 BP filter 1126. This may be especially useful for a case where the frequency of IF1 1129 is low, for example, below 1 GHz, and it is difficult to design IF1 BP filter 1126 to provide a 60 dB rejection at the third-order image frequency. A cascade of two or three polyphase filters 1124 may be designed to also provide a notch of 30 to 40 dB at a subband of the strong third-order image, which is opposite in frequency to the wanted subband of IF1 desired signal 1129. As a result, IF1 BP filter 1126 is designed mainly for the rejection of the fifth-order image (and higher-order images) in IF1 stage 1129, along with its enough attenuation at the third-order image frequency.

In addition, the design of filters 1126 and 1124 in IF1 stage 1129 should also provide enough rejection of the even-order images caused by the even-order mixing products, especially, the second-order image. Ideally, the mixer of differential circuits is free from the even-order images. However, any mismatches break the circuit symmetry and consequently degrade the internal cancellation of the even-order images.

Zero-IF double quadrature IR downconverter 1131 comprises four identical basic switching mixers. Double quadrature converter 1651 in FIG. 2C shows an embodiment of zero-IF double quadrature downconverter 1131. The mixer design is critical to this zero-IF downconverter 1131. The design tradeoff is focused on the optimal circuit performance in I/Q match, reverse isolation, flicker noise, second-order and third-order distortions, and DC-offset.

The I/Q mismatch of zero-IF double quadrature IR downconverter 1131 can be classified as external and internal mismatches. The external mismatch defines the mismatches in both the quadrature signal input in IF1 stage 1129 and quadrature LO signal 1184. The internal mismatch defines the mismatch inside zero-IF double quadrature downconverter 1131. The entire IF1 stage 1129 is considered as the input path of downconverter 1131. Due to the internal I/Q match imperfection of zero-IF double quadrature downconverter 1131, after downconversion, a suppressed frequency-inverted version of the desired signal in IF1 stage 1129 is superimposed on the desired signal in baseband 1139. Signals of digital standards can be approximately modeled as additive white Gaussian noise (AWGN). The frequency-inverted version of the desired signal is approximately an AWGN added to the desired signal, consequently degrading the C/N ratio in baseband 1139. Practically, zero-IF double quadrature downconverter 1131 is specified to have the internal I/Q mismatch of about 1%.

The phase noise of quadrature LO signal 1184 may leak to the inputs of the mixers in downconverter 1131 to corrupt the desired signal in IF1 stage 1129, and the amount of leaking is determined by the reverse isolation of the mixers. The leaked phase noise can be considered as an additional input-referred noise at the input of downconverter 1131. If the reverse isolation is low, the higher close-in phase noise of quadrature LO signal 1184 will add to the noise floor of the RF receiver significantly. Zero-IF double quadrature downconverter 1131 is constructed by using either active switching mixers or passive mixers.

A passive mixer is a voltage-to-voltage frequency converter and thus has very high linearity. However, its reverse isolation is typically lower than that of an active mixer. When the passive mixers are designed into zero-IF downconverter 1131, the extreme care is needed in the design and layout in order to minimize the LO leakage to the input ports.

Alternatively, an active switching mixer is able to achieve high reverse isolation. The principle of operation of the active mixers is technology-independent, and the mixers may be implemented by using bipolar or CMOS devices, or even combined CMOC/bipolar devices. Theoretically there is no flicker noise at the output of active CMOS mixer 4100 in FIG. 5A. However it has been found that this is only true when the LO signal at 4101 is a perfect square-wave signal. Flicker noise is mainly from the CMOS switching stage 4105. There are two effective solutions to improve flicker noise. The first solution is to use the size of switching transistors 4105 as large as possible, considering existence of the parasitic capacitance. The second one is to make the transition of the square-wave like LO signal at 4101 as short as possible. Conceptually an active bipolar mixer achieves better flicker noise performance than the active CMOS mixer at the same condition of the LO signal waveform. In active combined CMOC/bipolar mixer 4300 in FIG. 5B, four bipolar transistors are employed in switching stage 4305 in order to eliminate flicker noise and two CMOS transistors in input stage 4303 to improve the linearity of the voltage to current conversion.

In zero-IF double quadrature IR downconverter 1131, it is critical to minimize the second-order distortion since it creates a time-varying DC to the baseband, which is difficult to be canceled. By using a careful symmetric layout of zero-IF downconverter 1131, the second-order distortion can be reduced dramatically. The current boosting method, by using current sources 4107 in FIG. 5A or those 4307 in FIG. 5B, may be used optionally to increase the linearity of the input stage. Degeneration (not shown) may also be applied to the input-stage circuits to improve the linearity, especially for the bipolar input stage. The output DC-offset of zero-IF double quadrature downconverter 1131 becomes the input-referred DC-offset of the next baseband circuitry. This output DC-offset of zero-IF downconverter 1131 needs to be minimized and may be specified on the order of several mV, based on assumption of a 3 V supply voltage. The DC-offset and second-order distortion of zero-IF downconverter 1131 should be minimized by using adequately large component sizes, a careful layout technique and an accurate process. Note that conventional DC-offset compensation methods may be used in baseband 1139, especially for digital systems, which include highpass filters, feedback loops, and hybrid analog/digital solutions. In addition, a common-mode (CM) feedback network is needed in baseband 1136 to adequately control the output CM level.

In baseband 1139, the mismatch in the I and Q paths causes a frequency crosstalk between the positive and negative sidebands of the desired signal. These two sidebands of the baseband desired signal mirror each other. The crosstalk causes superposition of a suppressed mirror signal on the desired signal. Therefore, the I/Q matching performance of the baseband circuitry 1139 needs to be specified in order to have a satisfactory rejection of the baseband mirror signal. According to the C/N thresholds provided by digital TV standards such as the European DVB-T and DVB-H standards and the US digital TV standard (ATSC) standard, the I/Q matching requirement of baseband circuitry 1139 can be preferably defined as 1%. Note that conventional I/Q mismatch compensation methods may also be used in baseband 1139 if necessary. Among these methods are a gain mismatch compensation method, a phase error compensation method, and a method for the both. Most of these compensation methods work on the quadrature (complex) signal domain and are known by those skilled in the art.

One of the key efforts in baseband filter 1136 design is to identify a circuit topology which can achieve the highest possible degree of the I/Q match. Baseband lowpass filter 1136 can be a high-order lowpass filter of Butterworth-type or Chebyshev-type with a small ripple, although other types of lowpass filters may be considered as well. It is optional to use a bipolar/CMOS operational amplifier (OpAmp) based filter or a GmC filter in the circuit implementation. Typically in design, the first stage of lowpass filter 1136 is required to provide higher dynamic range and the following stage or stages are more relaxed. Among conventional configurations of lowpass filters, a ladder configuration can provide a low sensitivity to the spread of the circuit components.

A group-delay equalizer (not shown) may be employed in baseband stage 1139 next to baseband LP filter 1136 to compensate nonlinear phase distortion occurring in baseband stage 1139. A receive signal strength indicator (RSSI) circuitry (not shown) may be implemented at the output of baseband LP filter 1136 to indicate the desired signal level. A RSSI signal may be requested to send to a demodulator.

The PGA in PGA/Driver block 1141 is assigned in baseband stage 1139 for the AGC functionality. External AGC signal 1160, a multi-bit signal, is provided by a digital demodulator of a digital TV or cable modem system and via the serial data interface. The AGC function is used to deliver the optimal level of the desired signal at baseband output 1189 to the A/D converters. The AGC stages in PGA/Driver block 1141 may be embedded in the stages of baseband lowpass filter 1136, completely or partially, especially when multi-stage OpAmp-based lowpass filter 1136 is implemented. The gain control range may are from 30 to 60 dB with the control step of 1, 2, or more dB, based on system specifications.

The output driver next to the PGA in PGA/Driver block 1141 is designed to provide satisfactory output current and low output impedance to the A/D converters. It can be designed to provide programmable maximum differential and common-mode voltages at baseband output port 1189.

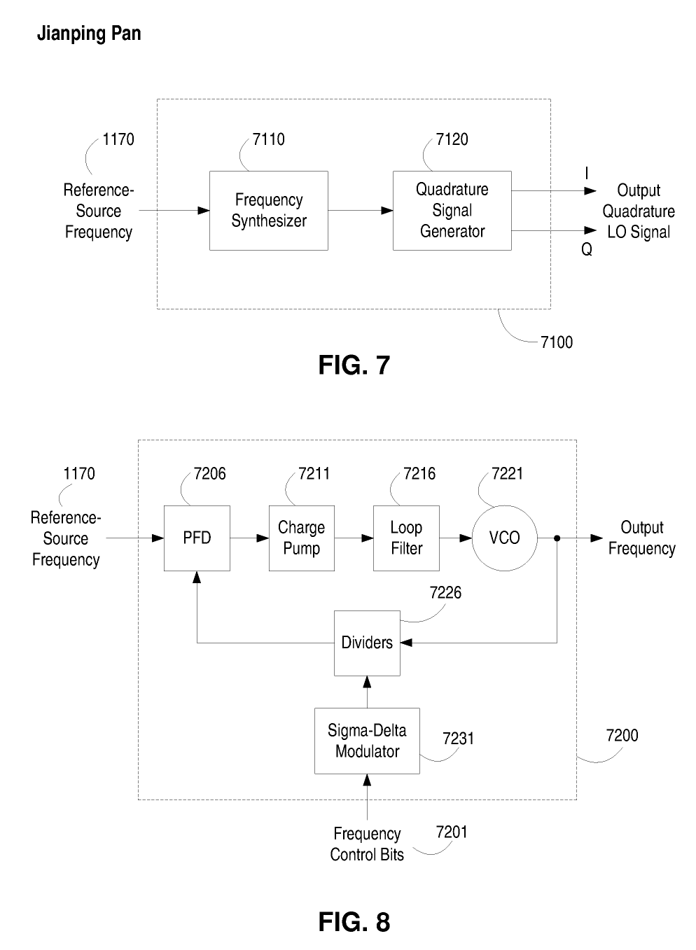

Two LO signal generators 1171 and 1181 are needed in dual-conversion tuner 1101 in FIG. 1 to provide quadrature LO (or reference) signals 1174 and 1184 to two converters 1121 and 1131, respectively. FIG. 7 provides an embodiment of quadrature LO signal generator 7100 comprising a frequency synthesizer 7110 and a quadrature signal generator 7120. Reference-source frequency 1170 used by LO signal generators 1171 and 1181 comes from crystal oscillator 1180. Crystal oscillator 1180 normally provides a very stable frequency and has much lower phase noise than any other oscillators in integrated tuner 1101. When there is no AFC function required, crystal oscillator 1180 is simply a basic crystal oscillator (XO). Most of XO circuits 1180 can be implemented on-chip except a crystal resonator. When the AFC function is employed, crystal oscillator 1180 is typically an external voltage-controlled oscillator (VCXO), and its frequency can be finely adjusted by external AFC signal 1190. AFC signal 1190 is typically an analog signal and is generated by a demodulator.

A Sigma-Delta (SD) fractional-N frequency synthesizer is a preferred solution among the frequency synthesizers. FIG. 8 shows an embodiment of SD fractional-N frequency synthesizer 7200, which can be used in frequency synthesizer 7110 in FIG. 7. A high frequency resolution is provided by synthesizing fractional multiples of reference-source frequency 1170 in digital SD modulator 7231 controlled dividers 7226. The spurious are whitened and shaped by Sigma-Delta modulation 7231 and are then filtered by loop filter 7216. Also included in synthesizer 7200 are a phase-frequency detector (PFD) 7206 and a charge pump 7211. SD fractional-N frequency synthesizer 7200 is programmed by external frequency control bits 7201. SD fractional-N frequency synthesizer 7200 is employed in first LO signal generator 1171 to provide channel tuning capability. Frequency synthesizer 7110 in LO signal generators 1181 for downconverter 1131 only needs to provide a fixed frequency. An integer-N frequency synthesizer may also be used.

It is optional to allow a (small) frequency offset in a pre-defined center frequency of IF1 1129, which is made to be channel-dependent. Benefits from this approach are: first, relaxing the resolution requirement of tunable frequency synthesizer 7110 in first LO signal generator 1171; and second, providing a solution to cope with some possible beats between harmonics from LO signal generators 1171 and 1181, which fall into baseband 1139 interfering with the wanted signal and can be calculated from the frequencies of these harmonics. Then frequency synthesizer 7110 in second LO signal generator 1181 is required to have a capability of compensating, by programming, the channel-dependent offset in the center frequency of IF1 1129 so that the desired signal in baseband 1139 possesses a zero frequency offset, or possibly a small frequency offset known to the digital demodulator for the digital cancellation of this frequency offset.

First LO signal generator 1171 provides a tunable-frequency LO signal 1174 to first single quadrature converter 1121. The tuning range of LO 1171 is provided to convert the desired signals of the channels in the signal band to IF1 1129. F_{LO}=F_{IF}1 +F_{CH}, where, F_{LO} is the tunable LO frequency of first LO signal generator 1171, F_{IF}1 is the frequency of IF1 1129, and F_{CH} is the center frequency of a selected channel. Retuning to FIG. 8, tunable VCO 7221 may be a conventional LC VCO, and its design usually employs a switchable capacitor bank to provide a wide-range tuning. Multiple VCO circuit blocks may be designed to ease the tuning complexity. The frequency of LO signal 1184 is usually fixed, equal to the frequency of IF1 1129. The VCO used in second LO signal generator 1181 can also be a LC VCO.

In the design of the VCOs in first and second LO signal generators 1171 and 1181, the requirements in phase noise, especially close-in phase noise, should be based on system specifications of digital standards. The phase noise of VCOs should be low enough in order to prevent a digital demodulation from symbol jitters and minimize smearing of the constellation in a high-rate QAM demodulation. The phase noise specification of a LO signal generator is often defined relative to some interesting frequency offsets from the VCO oscillation frequency. Examples of these frequency offsets are 10 kHz, 20 kHz, 100 kHz, and 1 MHz. A reasonable phase noise specification is expected as: −85˜−95 dBc/Hz at 10 kHz, −90˜−100 dBc/Hz at 20 kHz, −105˜−120 dBc/Hz at 100 kHz, and −120˜−140 dBc/Hz at 1 MHz, where, dBc indicates dB relative to the power level at the center frequency.

Frequencies of the VCOs and the LO signals may not be the same in the first and second LO signal generators 1171 and 1181. Frequencies of the VCOs may be twice, four- or eight-times those of the (output) LO signals in LO signal generators 1171 and 1181. The higher-frequency VCO in frequency synthesizer 7110 may be required by quadrature signal generator 7120 in FIG. 7. It may also be required to avoid the VCO frequency re-radiation to RF input port 1100 in the signal band. The tunable frequencies of VCO 7221 in FIG. 8 used in first LO signal generator 1171 may be made as configurable multiples of two of the LO output frequency. During channel tuning, a smallest multiple of two which still makes VCO 7221 frequency higher than the signal band is programmed. This method can possibly reduce the VCO tuning range and thus reduce the VCO circuit complexity.

Returning to FIG. 7, quadrature signal generator 7120 in quadrature LO signal generator 7100 can be implemented by using two conventional methods: polyphase filters or divide-by-2 dividers. A cascade of polyphase filters, the same as polyphase filter 5730 shown in FIG. 6B, acts as a quadrature signal generator which inputs a single differential signal and outputs a quadrature differential signal. When the polyphase filters are used in tunable LO signal generator 1171, a switchable capacitor bank (not shown) may be designed in each stage of the polyphase filters to cover the frequency tuning range. The quadrature matching performance of the polyphase filters corresponds to the mirror rejection amount of the quadrature LO signal. Designs of quadrature LO signal generators 7100 in LO signal generators 1171 and 1181 should satisfy the previously described I/Q matching requirements of quadrature LO signals 1174 and 1184, respectively.

Alternatively, a quadrature LO signal can be generated by divide-by-2 dividers. The divide-by-2 dividers can be implemented using a master-slave toggle flip-flop circuit or a four-phase divide-by-2 circuit, which are known to those skilled in the art. Frequency synthesizer 7110 in quadrature LO signal generator 7100 is then required to provide a frequency which is twice or four-times the output quadrature LO frequency. Quadrature LO signal generator 7100 using divide-by-2 dividers typically has better I/Q matching performance and does not need a switchable bank in quadrature signal generator 7120 when the LO frequency is tunable. Therefore quadrature LO signal generator 7100 using divide-by-2 dividers is preferable in first tunable LO signal generator 1171 for channel tuning. Besides, a quadrature LO signal may be directly generated by a quadrature VCO which is known in the art.

In the following embodiments of integrated tuners, the blocks corresponding to the blocks in FIG. 1 are indicted with the same reference numerals, and they are substantially the same in function. Therefore these previously described blocks will not be described again. Also in the following, the block of a same reference numeral occurring in an embodiment will not be described again in later embodiments.

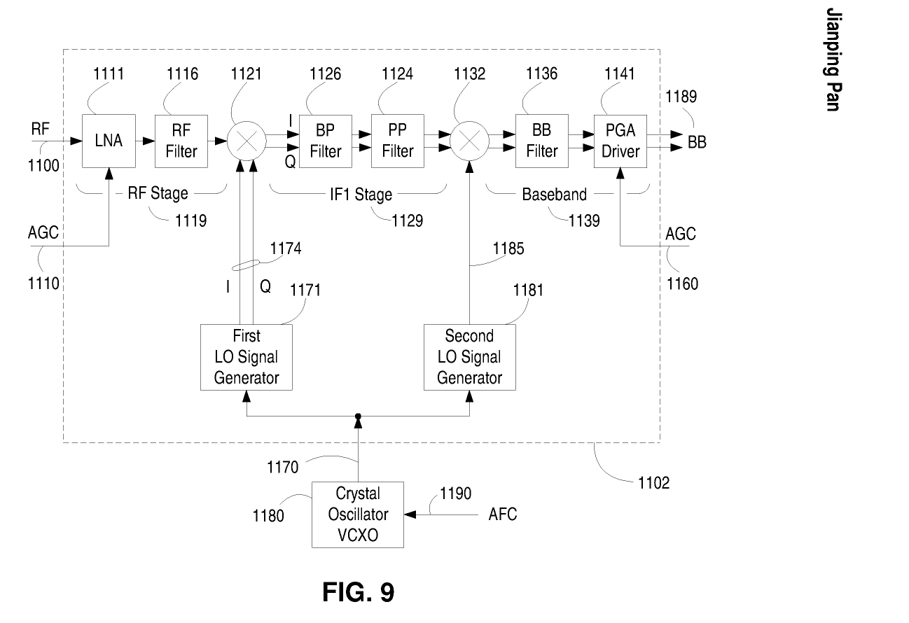

Another preferred embodiment of an integrated tuner of dual-conversion architecture 1102, in accordance with the present invention, is provided in FIG. 9, which is derived from the integrated tuner of dual-conversion architecture 1101 in FIG. 1 by replacing zero-IF double quadrature downconverter 1131 in FIG. 1 with a type-II single quadrature downconverter 1132. FIG. 2B shows an embodiment 1631 of type-II single quadrature downconverter 1132. In FIG. 9, LO signal 1185 is a (real) differential LO signal fed to type-II single quadrature downconverter 1132. Note that locations of polyphase filter 1124 and bandpass filter 1126 may be preferably exchanged in IF1 stage 1129 for a slightly better image rejection performance. For the target overall image rejection of 80 dB, due to the fact that type-II single quadrature downconverter 1132 has no rejection capability of the (first-order) image in IF1 stage 1129, polyphase filter 1124 in IF1 stage 1129 needs to provide enough rejection, for example, about 40 dB, of the image.

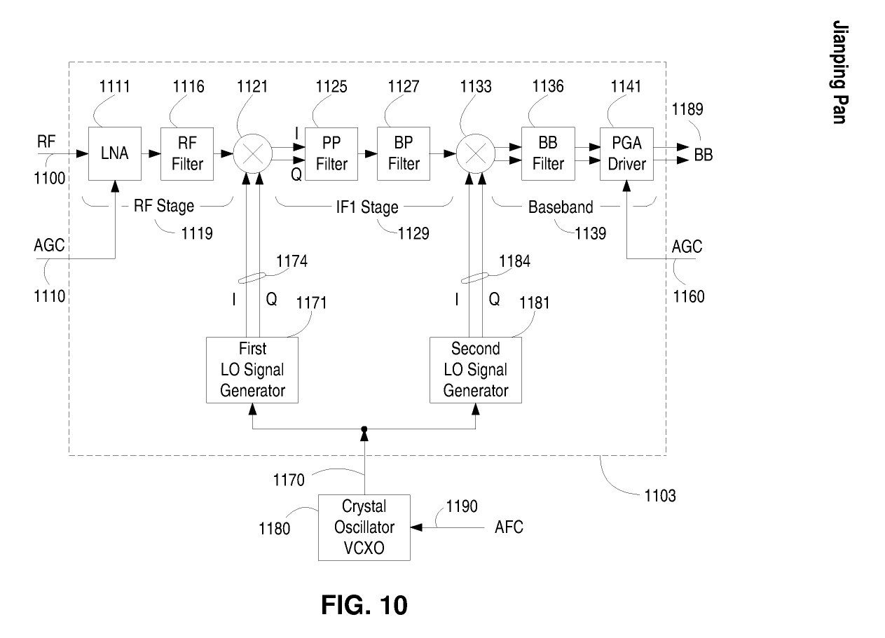

Another preferred embodiment of an integrated tuner of dual-conversion architecture 1103, in accordance with the present invention, is provided in FIG. 10, which is derived from the integrated tuner of dual-conversion architecture 1101 in FIG. 1 by replacing zero-IF double quadrature downconverter 1131 in FIG. 1 with a type-I single quadrature downconverter 1133. FIG. 2A shows an embodiment 1611 of type-I single quadrature downconverter 1133. Polyphase filter 1125 then has a quadrature input and a real output. FIG. 6C shows an embodiment 5720 of polyphase filter 1125. For the target overall image rejection of 80 dB, polyphase filter 1125 needs to provide enough rejection, about 40 dB, of the (first-order) image before converting the quadrature input signal into the real output signal in IF1 stage 1129. Bandpass filter 1127 is then a real filter and provides rejection of the third-order and higher-order images in zero-IF type-I single quadrature downconverter 1133.

The above integrated tuners of dual-conversion, with the second zero-IF downconversion, can apply to most of television systems. Among them, the terrestrial digital TV standards are particularly important, especially when the terrestrial analog TV standards are phased out. The standards of DVB-T and ATSC are two good examples, where the C/N ratio thresholds required are relatively low, compared to the cable TV and analog TV standards. This fact puts less challenge in designing the baseband-stage circuits to meet the I/Q matching requirements. The target overall image rejection of 80 dB above is, as said, just a design example, and in terrestrial digital TV systems, the required image rejection is usually lowered to 60 to 70 dB.

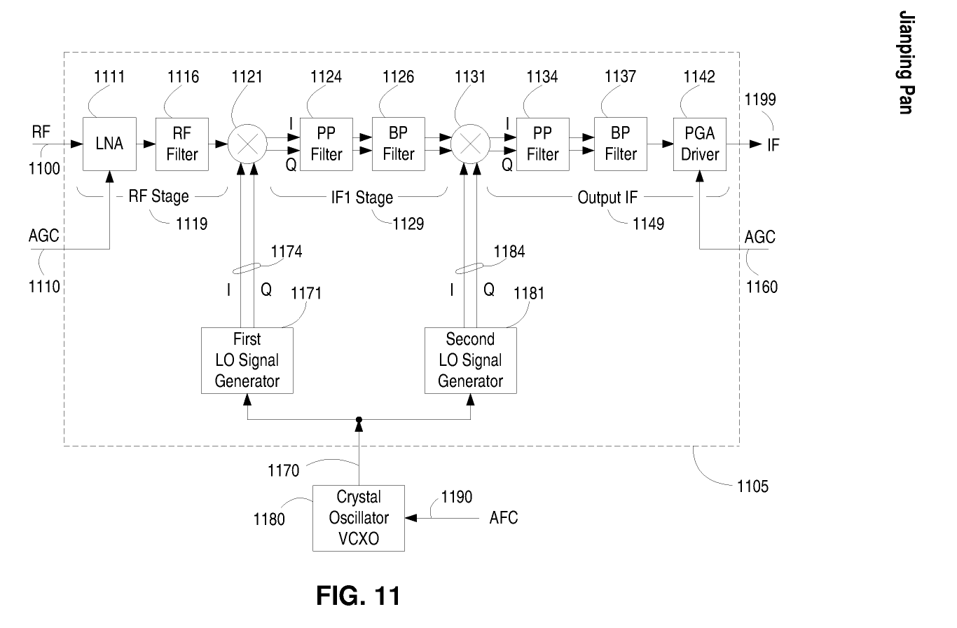

FIG. 11 is a block diagram of a preferred embodiment of an integrated tuner of dual-conversion architecture 1105 in accordance with the present invention. First conversion 1121 converts the desired signal of a selected channel in the signal band to a first high-frequency IF1 1129. Locations of polyphase filter 1124 and bandpass filter 1126 can be exchanged. Then a low-IF double quadrature downconverter 1131 downconverts the desired signal in IF1 stage 1129 to a low-frequency output IF 1149. The center frequency of output IF 1149 is preferably defined in the range of one half to one of the channel spacing of RF signal 1100. Dual-conversion tuner 1105 can interface with a demodulator able to provide this low-IF input interface. A polyphase filter 1134 first rejects an image in output IF 1149. A bandpass filter 1137 then provides channel selection and suppresses interference signals according to system specifications of digital TV standards. A group-delay equalizer (not shown) may be employed in output IF 1149 to compensate nonlinear phase distortion occurring in output IF 1149. A RSSI circuitry (not shown) may be implemented in output IF 1149 to generate a RSSI signal. A PGA in a PGA/Driver block 1142 amplifies the desired signal according to AGC signal 1160. A driver in PGA/Driver block 1142 provides a low impedance IF output 1199 to interface with an A/D converter of a digital demodulator.

The center frequency of IF1 1129 can be defined around 1 GHz to relax the design of RF IR filter 1116. Also IF1 BP filter 1126 can be designed as low-Q LC bandpass filter to reject the third-order and higher-order images at IF1 1129.

In a cable distribution network, the frequency spectrum of the useful signals is highly regulated in the regular or extended signal band, and there are much weaker sources of interference signals and other noises above the signal band. Therefore, IF1 1129 frequency planning may advantageously utilize this good feature of the cleaner spectrum in the cable distribution network to simplify the design of RF IR filter 1116. For a cable network using the regular signal band of 50 to 870 MHz, the exemplary frequency of IF1 1129 may be defined as low as 415 MHz. Thus there are no images situated at the regular signal band. For a cable network using the extended signal band of 40 MHz to 1 GHz, the exemplary frequency of IF1 1129 may be defined as low as 480 MHz. Thus there are no images situated at the extended signal band. Consequently, RF IR filter 1116 may only be designed to provide some degree of protection for the weak interference signals and noise above the signal band, according to system specifications of cable TV/modem standards. RF IR filter 1116 bank may comprise a combination of RC lowpass and highpass filters and GmC lowpass/bandpass filters and possibly LC bandpass filters.

The rationale of defining such a low frequency of output IF 1149 is that the Carrier-to-Interference (C/I) ratios of two adjacent channels are normally higher or much higher than those of other non-adjacent channels in most TV systems. A low-IF downconversion has advantages in coping with circuit issues which are well known in a zero-IF downconversion, like DC-offset and flicker noise (in a CMOS implementation). Because the center frequency of output IF 1149 is defined in the range of one half to one of the channel spacing of RF signal 1100, the (first-order) image in low-IF downconverter 1131 is substantially caused by a lower or higher adjacent channel. Polyphase filter 1134 rejects the image which is opposite, in frequency, to the desired sideband of the wanted signal in output IF 1149. In summary, the rejection of the low-frequency (first-order) image in low-IF downconverter 1131 is accomplished by quadrature IR downconverter 1131 and polyphase filter 1134. A good design of quadrature IR downconverter 1131 and polyphase filter 1134 can achieve an image rejection of 45 to 60 dB, based on the present CMOS process technology. For this purpose, low-IF downconverter 1131 may be preferably designed using passive CMOS mixers 6700 shown in FIG. 4 and possible buffer amplifiers. Lowering the frequency of IF1 1129 generally helps this image rejection performance of downconverter 1131.

Here is a first preferred example of defining polyphase filter 1134 and bandpass filter 1137. IF polyphase filter 1134 is designed to have satisfactory suppression of the image in output IF 1149. For the image rejection of around 50 dB, the I/Q matching requirement of polyphase filter 1134 is specified as around 0.3%. Polyphase filter 1134 then converts the quadrature differential IF signal to a real differential IF signal (this operation occurs inside IF BP filter 1137). BP filter 1137 is then a real signal filter and is defined to provide channel selectivity and suppression of interferences. It also acts as an anti-aliasing filter for an A/D converter. BP filter 1137 is typically designed as a cascade of OpAmp-based filter stages and may need prior art auto-tuning. A gain of 10 to 40 dB is distributed among the stages of BP filter 1137.

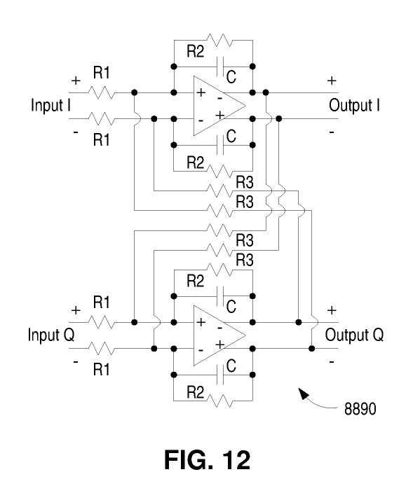

Here is a second preferred example of defining polyphase filter 1134 and bandpass filter 1137. A two- to three-stage polyphase filter 1134 is designed to provide an image suppression of 30 to 40 dB. An active complex bandpass filter is defined for BP filter 1137. Due to the image suppression by polyphase filter 1134, the I/Q matching specification of active complex bandpass filter 1137 can be relaxed significantly. Complex bandpass filter 1137 provides an additional suppression of the IF image for a total image rejection requirement. Active complex bandpass filter 1137 is designed based on operational or Gm amplifiers. An embodiment of complex bandpass filter 1137 is a multi-stage complex bandpass filter. FIG. 12 shows one stage 8890 of multi-stage OpAmp-based complex bandpass filter 1137. The quadrature differential output signal of complex bandpass filter 1137 is then converted into a single differential output signal. Note that polyphase filter 1134 may be removed and only active complex bandpass filter 1137 is designed to meet the requirements of IF image rejection and IF signal filtering.

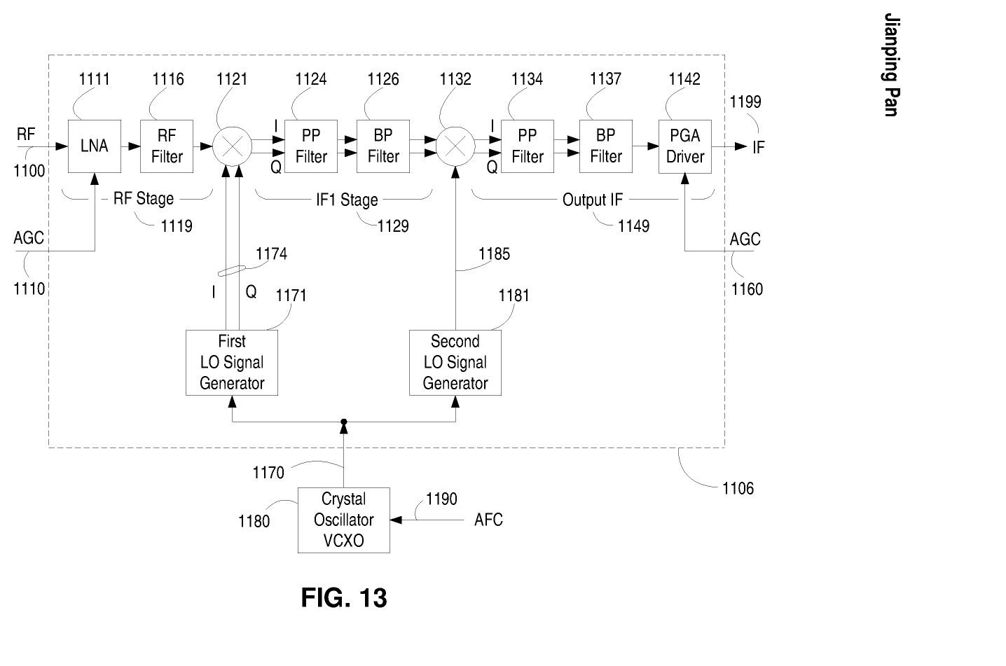

Another preferred embodiment of an integrated tuner of dual-conversion architecture 1106, in accordance with the present invention, is provided in FIG. 13, which is derived from the integrated tuner of dual-conversion architecture 1105 in FIG. 11 by replacing low-IF double quadrature downconverter 1131 in FIG. 11 with a type-II single quadrature downconverter 1132. FIG. 2B shows an embodiment 1631 of type-II single quadrature downconverter 1132. In FIG. 13, LO signal 1185 is a (real) differential LO signal fed to type-II single quadrature downconverter 1132. Note that polyphase filter 1124 and bandpass filter 1126 may be preferably exchanged for their locations in IF1 stage 1129 for a slightly better image rejection performance. Dual-conversion tuner 1106 in FIG. 13 has a rejection performance of the image in the second low-IF downconversion lower than dual-conversion tuner 1105 in FIG. 11.

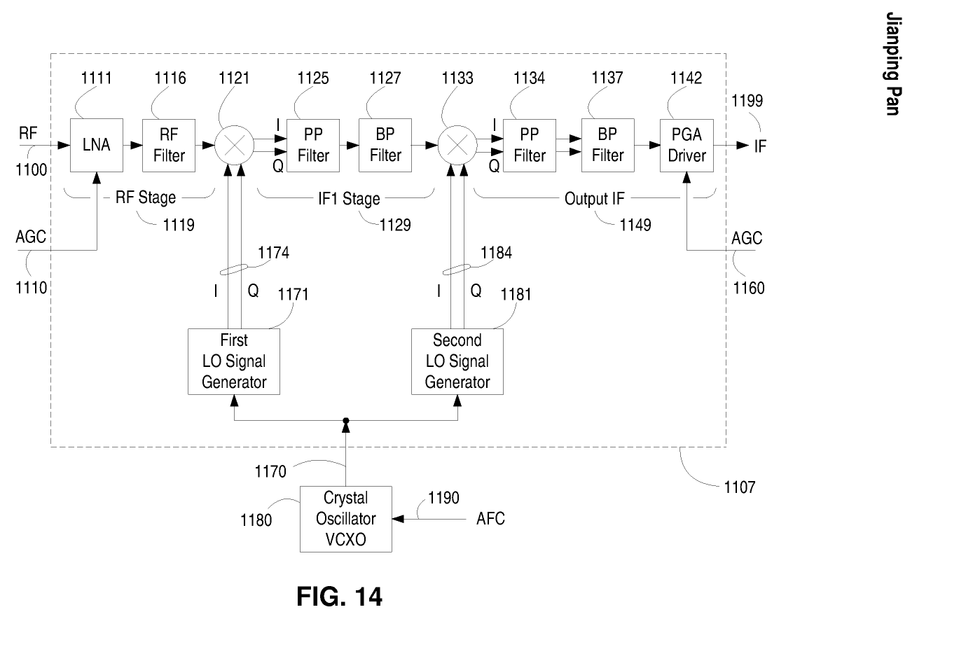

Another preferred embodiment of an integrated tuner of dual-conversion architecture 1107, in accordance with the present invention, is provided in FIG. 14, which is derived from the integrated tuner of dual-conversion architecture 1105 in FIG. 11 by replacing low-IF double quadrature downconverter 1131 in FIG. 11 with a type-I single quadrature downconverter 1133. FIG. 2A shows an embodiment 1611 of type-I single quadrature downconverter 1133. Polyphase filter 1125 then has a quadrature input and a real output. FIG. 6C shows an embodiment 5720 of polyphase filter 1125. Polyphase filter 1125 needs to provide enough image rejection before converting the quadrature input signal into the real output signal in IF1 stage 1129. Bandpass filter 1127 is then a real filter and provides rejection of the third-order and higher-order images in low-IF type-I single quadrature downconverter 1133. Dual-conversion tuner 1107 in FIG. 14 has a rejection performance of the image in the second low-IF downconversion lower than dual-conversion tuner 1105 in FIG. 11.

The above integrated tuners of dual-conversion, with the second low-IF downconversion, 1105 in FIG. 11, 1106 in FIG. 13 and 1107 in FIG. 14, can apply to most of television systems. Among them, the cable TV standards and the cable modem standards are particularly important. The OpenCable and Data-Over-Cable Service Interface Specifications (DOCSIS) standards are two good examples. The adjacent channel performance requirements of these two standards make it practically possible for these tuners with second low-IF downconversion to meet the low-IF image rejection specifications, according to present process technology.

The center frequency of output IF 1149 in dual-conversion tuners 1105 in FIG. 11, 1106 in FIG. 13 and 1107 in FIG. 14 can also be defined as popular IF frequencies of, for example, 44 MHz, 36 MHz, etc. Then polyphase filter 1124 and bandpass filter 1126 (or filters 1125 and 1127 in FIG. 14) need to reject not only the high-order images but also the more important (first-order) image in IF1 stage 1129. Dual-conversion tuners 1105 in FIG. 11 is a preferred embodiment for offering the higher-frequency output IF 1149. For the same principle described above, the uses of quadrature signal format in IF1 stage 1129 and polyphase filter 1124 to reject the IF image, which mirrors the desired sideband of the wanted signal in IF1 stage 1129, can effectively relax the (first-order) image rejection requirement of bandpass filter 1126 by 30 to 40 dB. Consequently, for an exemplary total image rejection requirement of 60 dB, bandpass filter 1126 may only need to reject the image by as low as 20 dB when the I/Q matching performance of low-IF double quadrature downconverter 1131 can be better than 1%. The image is eventually rejected by polyphase filter 1134 and possibly bandpass filter 1137 in output IF 1149.

For some applications, it is reasonable to have an integrated tuner design to include a combination of the integrated tuners disclosed by this invention and to switch to one tuner for a specific RF signal source, manually or automatically. Here is an example of designing a tuner for both terrestrial and cable digital TV standards. A tuner design includes dual-conversion tuner 1101 in FIG. 1 and dual-conversion tuner 1105 in FIG. 11. When a digital terrestrial TV signal is received, tuner 1101 is switched on; when a digital cable TV is received, tuner 1105 is switched on. Automatic switching control signal can be generated in a demodulator according to modulation information or using messages from upper layers in digital systems. Assume that the demodulator provides flexibility of baseband and low-IF input interface. This tuner design may be very useful for an advanced television set which is able to receive both the terrestrial TV signal and the cable TV signal. Furthermore, it is optional to use a single-downconversion to directly downconverts RF signal 1119 into baseband 1139 or low-IF 1149 for some high-frequency channels, for example, whose center frequencies are higher than 600 MHz.

Although the present invention and some embodiments have been described in detail, it should be understood that the aforesaid embodiments illustrate rather than limit the invention, and that various alternative embodiments can be made herein without departing from the spirit or scope of the invention as defined by the appended claims. Although the description above contains many requirements and specifications, these should not be construed as limiting the scope of the invention but as providing illustrations of some of the presently preferred embodiments of this invention. Thus the scope of the invention should be determined by the appended claims.

What is claimed is:

1. An integrated tuner for receiving a radio frequency (RF) signal, in a frequency band, which takes the form of at least one of a terrestrial TV signal, a cable TV signal, a digital data signal transmitted over a cable system, a terrestrial digital data signal, and a broadcast audio signal, comprising:
1. a first quadrature reference signal having a first frequency;
2. a second reference signal having a second frequency;
3. a first type-I single quadrature converter having a signal input coupled to the RF signal and a reference input coupled to the first quadrature reference signal, generating a first intermediate frequency (IF) signal at an output; and
4. a second converter having a signal input coupled to the first IF signal and a reference input coupled to the second reference signal, and generating a second IF signal at an output, wherein a center frequency of the second IF signal is in an approximate range of 0 Hz to one of a channel spacing of the RF signal;
whereby the first type-I single quadrature converter substantially relaxes design of RF stage circuitry.

2. The integrated tuner of claim 1 wherein the first frequency of the first quadrature reference signal is tunable for tuning of a selected channel of the RF signal in the frequency band; the center frequency of the first IF signal is in a range of 400 Mega-Hz (MHz) to 2 Giga-Hz (GHz); the integrated tuner further comprises:
1. an RF filter having an input coupled to the RF signal for filtering unwanted signals, wherein the signal input of the first type-I single quadrature converter is coupled to the RF signal by the RF filter;
2. a first IF bandpass filter coupled to the output of the first type-I single quadrature converter for filtering the first IF signal; wherein the signal input of the second converter is coupled to the first IF signal by the first IF bandpass filter;
3. a second IF filter coupled to the output of the second converter for filtering the second IF signal;
4. a first reference signal generator generating the first quadrature reference signal of the tunable first frequency; and
5. a second reference signal generator generating the second reference signal.

3. The integrated tuner of claim 2 further comprising:
1. an RF amplifier having an input coupled to the RF signal, wherein the input of the RF filter is coupled to the RF signal by the RF amplifier;
2. a first IF amplifier amplifying the first IF signal;
3. a second IF amplifier coupled to an output of the second IF filter;
4. an RF automatic gain control (AGC) signal which adjusts gain of the RF amplifier;
and
5. an IF AGC signal which adjusts gain of at least one of the first IF amplifier and the second IF amplifier.

4. The integrated tuner of claim 2 further comprising:
an IF polyphase filter for suppressing at least an image in the first IF signal, having an input coupled to the output of the first type-I single quadrature converter and an output coupled to the input of the first IF bandpass filter.

5. The integrated tuner of claim 2 further comprising:
an IF polyphase filter for suppressing at least an image in the first IF signal, having an input coupled to the output of the first IF bandpass filter and an output coupled to the signal input of the second converter.

6. The integrated tuner of claim 2 wherein the second converter is a double quadrature converter, the second reference signal is a quadrature reference signal.

7. The integrated tuner of claim 2 wherein the second converter is a type-I single quadrature converter, the second reference signal is a quadrature reference signal.

8. The integrated tuner of claim 2 wherein the second converter is a type-II single quadrature converter.

9. The integrated tuner of claim 2 wherein the center frequency of the second IF signal is 0 Hz; the second IF signal is a baseband signal.

10. An integrated tuner for receiving an RF signal, in a frequency band, which takes the form of at least one of a terrestrial TV signal, a cable TV signal, a digital data signal transmitted over a cable system, a terrestrial digital data signal, and a broadcast audio signal, comprising:
1. a first reference signal having a first frequency;
2. a second reference signal having a second frequency;
3. a first single quadrature converter having a signal input coupled to the RF signal and a reference input coupled to the first reference signal, generating a first IF signal at an output; and
4. a second converter having a signal input coupled to the first IF signal and a reference input coupled to the second reference signal, and generating a baseband signal at an output;
whereby the first single quadrature converter substantially relaxes design of RF stage circuitry.

11. The integrated tuner of claim 10 wherein the first frequency of the first reference signal is tunable for tuning of a selected channel of the RF signal in the frequency band; the center frequency of the first IF signal is in a range of 400 MHz to 2 GHz; the integrated tuner further comprises:
1. an RF filter having an input coupled to the RF signal for filtering unwanted signals, wherein the signal input of the first single quadrature converter is coupled to the RF signal by the RF filter;
2. a first IF bandpass filter coupled to the output of the first single quadrature converter for filtering the first IF signal; wherein the signal input of the second converter is coupled to the first IF signal by the first IF bandpass filter;
3. a baseband lowpass filter coupled to the output of the second converter for filtering the baseband signal;
4. a first reference signal generator generating the first reference signal of the tunable first frequency; and
5. a second reference signal generator generating the second reference signal.

12. The integrated tuner of claim 11 further comprising:
1. an RF amplifier having an input coupled to the RF signal, wherein the input of the RF filter is coupled to the RF signal by the RF amplifier;
2. a first IF amplifier amplifying the first IF signal;
3. a baseband amplifier coupled to an output of the baseband lowpass filter;
4. an RF AGC signal which adjusts gain of the RF amplifier; and
5. an IF AGC signal which adjusts gain of at least one of the first IF amplifier and the baseband amplifier.

13. The integrated tuner of claim 11 wherein the first single quadrature converter is a type-II single quadrature converter.

14. The integrated tuner of claim 11 wherein the first single quadrature converter is a type-I single quadrature converter, the first reference signal is a quadrature reference signal.

15. The integrated tuner of claim 13 further comprising:
an RF polyphase filter for suppressing at least an image in the RF signal, having an input coupled to the output of the RF filter and a quadrature output coupled to the signal input of the first type-II single quadrature converter.

16. The integrated tuner of claim 14 further comprising:
an IF polyphase filter for suppressing at least an image in the first IF signal, having an input coupled to the output of the first type-I single quadrature converter and an output coupled to the input of the first IF bandpass filter.

17. The integrated tuner of claim 14 further comprising:
an IF polyphase filter for suppressing at least an image in the first IF signal, having an input coupled to the output of the first IF bandpass filter and an output coupled to the signal input of the second converter.

18. The integrated tuner of claim 14 wherein the second converter is a double quadrature converter, the second reference signal is a quadrature reference signal.

19. The integrated tuner of claim 14 wherein the second converter is a type-I single quadrature converter, the second reference signal is a quadrature reference signal.

20. The integrated tuner of claim 14 wherein the second converter is a type-II single quadrature converter.
